(19) United States
(12) Patent Application Publication
(10) Pub. No.: US 2008/0132097 A1
(43) Pub. Date: Jun. 5, 2008

(54) INTERCONNECTED APPARATUS UTILIZING METAL ON ELASTOMER RING CHAIN STYLE

(75) Inventors: Robert Florence, Poughkeepsie, NY (US); Vincent Mulligan, Wappinger Falls, NY (US); Thomas Ramundo, Albany, NY (US); Charles Tompkins, Poughkeepsie, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/565,091

(22) Filed: Nov. 30, 2006

(51) Int. Cl. H01R 25/00

(52) U.S. Cl. 439/110

(57) ABSTRACT

A connector for the interconnection of electrical components, the connector component comprising a framing segment, a planar grid constructed from a plurality of contact support cores, rails, and conductive annular cylinders, wherein the conductive annular cylinders comprising a predetermined geometric configuration, the rails are formed with a plurality of holes that are spaced a predetermined distance apart from one another along length of the body of the rail, and the plurality of contact support cores longitudinally extending through the holes that are formed within the plurality rails and the conductive annular cylinders. The rails and conductive annular cylinders being positioned along the length of a contact support core so that a conductive annular cylinder is positioned in the spacing between rails, further, the plurality conductive annular cylinders physically protrude beyond the width of the bodies of the plurality rails to form a conductive contact area surface. Further, the planar grid is mechanically mounted to framing segment.

### BACKGROUND OF THE INVENTION

1. Field of the Invention

This invention relates to electrical interconnecting components, and particularly to interconnecting devices that are constructed using ring-chain style configurations.

2. Description of Background

Before our invention, conventionally, multi-chip mounted (MCM) packages were constructed by connecting semiconductor processing chips to a system board using high-density interconnection substrates that typically comprised cinch buttons. Specifically, the cinch buttons were used to facilitate the connection between the processing chip and the system board. Typically, cinch buttons are composed of a contact, the contact being used to electrically connect the processing chip to the system board. The contact typically has a cylindrical shape, with a section of electrically conductive wire wound within the inside of the cylinder. Further, the contact can be compressed elastically over an axial displacement area when connected between the processing chip and the system board. However, the uses of cinch buttons as an interconnection solution have been problematic. MCMs constructed using cinch buttons run the risk of having electrical shorts, or open connection problems occur between the processing chip and the system board due to the physical composition of the cinch button. Therefore, there exists a need for an interconnection apparatus that has a more reliable contact feature mechanism than a conventional interconnection apparatus.

### SUMMARY OF THE INVENTION

The shortcomings of the prior art are overcome and additional advantages are provided through the provision of a connector component for the electrical interconnection of electrical components, the connector component comprising a framing segment, wherein the framing segment is a planar surface having a top surface and a bottom surface, a planar grid, having a top planar surface and a bottom planar surface, constructed from a plurality of contact support cores, rails, and conductive annular cylinders, wherein the conductive annular cylinders comprise an outside surface, the outside surface area of the conductive annular cylinders further comprising a predetermined geometric configuration, the rails are formed with a plurality of holes that are spaced a predetermined distance apart from one another along length of the body of the rail, and the plurality of contact support cores longitudinally extending through the holes that are formed within the plurality rails and the conductive annular cylinders, the rails and conductive annular cylinders being positioned along the length of a contact support core so that a conductive annular cylinder is positioned in the spacing between rails, further, the plurality conductive annular cylinders physically protrude beyond the width of the bodies of the plurality rails to form a conductive contact area surface, and further, the bottom surface of the planar grid is mechanically mounted to the top surface of the framing segment.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a MCM package.

FIG. 2A illustrates one example of a grid component of the present invention

FIG. 2B illustrates one example of a detailed view of the grid component of the present invention.

FIGS. 3A-3D illustrate examples of electrical conducting contacts that may be implemented within aspects of the present invention.

FIG. 4 illustrates one example of an interconnection apparatus.

FIGS. 5A-5B illustrates one example of the interconnect apparatus between a system processor and a system board

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only, since numerous modifications and variations therein will be apparent to those of ordinary skill in the art. In reference to the drawings, like numbers will indicate like parts continuously throughout the view.

Currently, metal on elastomer electrical connector configurations are well known designs in the art. The design of the present invention is novel due in part to its structural configuration. The performance characteristics of the present invention as an electrical interconnecting apparatus are enhanced by the structural configuration of the present invention (e.g., by providing improved AC and DC electrical conduction characteristics). The size and mass of the electrically conductive component contacts of the present invention have the capability to efficiently conduct a current, while keeping crosstalk to a minimum. Specifically, the electrical current conducting characteristics of the present invention is enhanced due to the geometry (i.e., a continuous loop) of the electrically conductive components comprised within the electrical connector as disclosed within the present invention. Further, based upon the length of the electrically conductive contact, the electrically conductive connectors provides low signal attenuation, in addition to low crosstalk between signals, due in part to the length of the electrically conductive contacts, and because there is no overlap of the electrically conductive contacts that are implemented within aspects of the present invention.

Aspects of the present invention are constructed utilizing electrically conductive contacts made of beryllium copper (BeCu) that are plated with gold. The construction of this component is not limited to beryllium copper; therefore similar conductive materials may be utilized to craft the conductive contacts. Within the present invention the electrically conductive contacts can comprise a ring or sleeve (bushing) shape, however, the electrically conductive contacts are not limited to these two shapes. The electrically conductive contacts are mounted onto and supported by a contact support core such that the electrically conductive contacts can be compressed between two surfaces in one direction against the contact support core. Accordingly, when the force is removed from the electrically conductive contacts, the contact support core expands, and therefore the electrically conductive contacts return to their original shape.

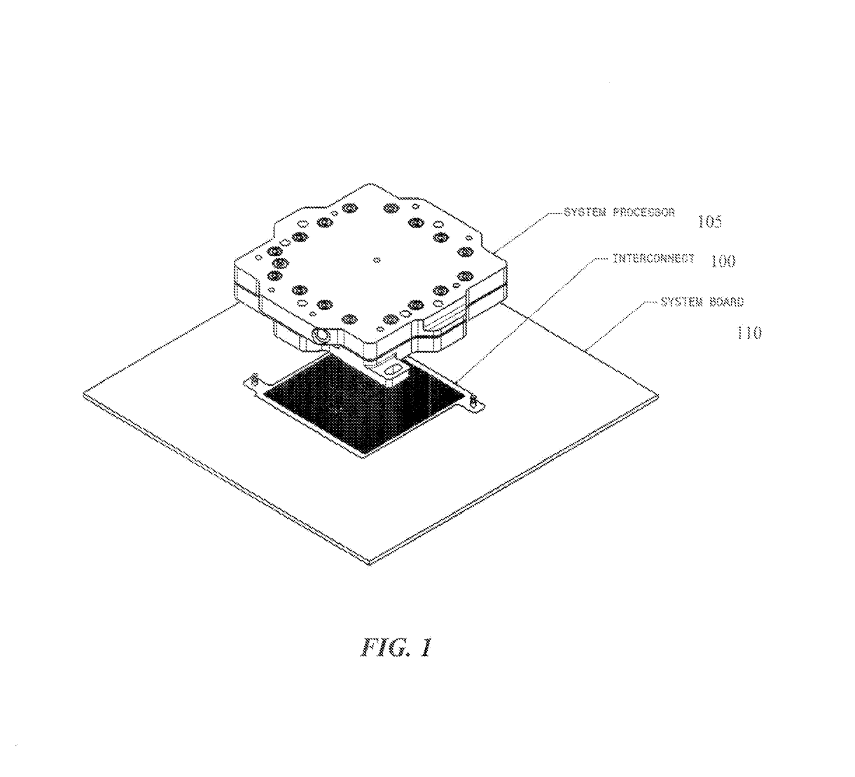

Aspects of the current invention provide for the constructing of a conductive array grid, wherein the grids are comprised of an array of contact support cores with several electrically conductive contacts mounted upon each contact support core, thus producing an array of rows and columns of electrically conductive contacts. As configured, the contact support cores align the electrically conductive contacts with the electrical pads contained on the surfaces of the system processor and the system board that are to be connected. As shown in FIG. 1, the connecter 100 is compressed between a system processor 105 and a system board 110 to form the electrical contact between the two.

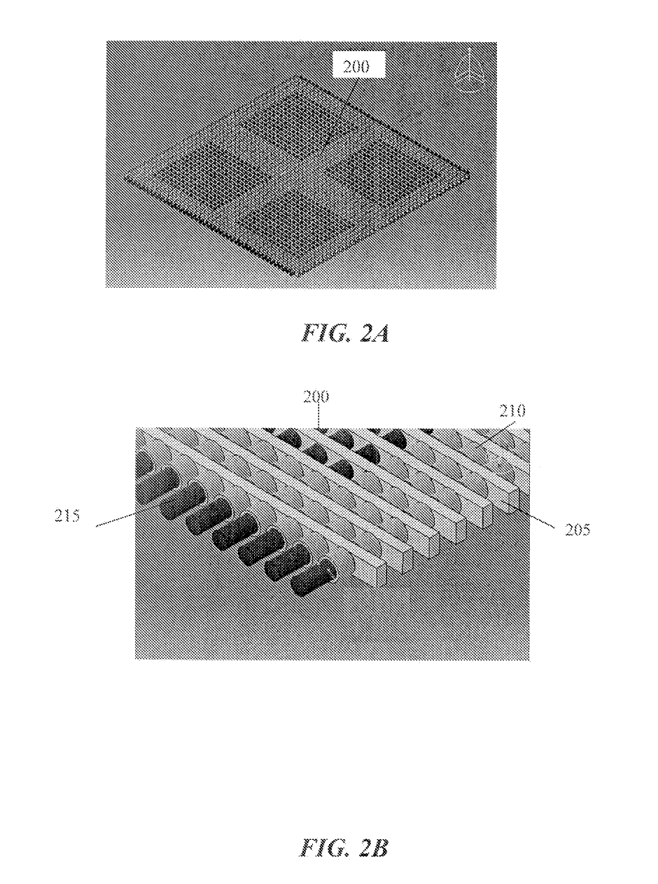

It will be seen that in FIGS. 2A and 2B there is an interconnecting apparatus contact grid 200 utilizing electrically conductive metal contacts 210 on contact support cores 215, wherein the contact support cores 215 are restrained by the use of interconnecting rails 205. FIG. 2B shows an exploded view of the contact grid 200, and the components that comprise the contact grid 200. The contact grids are comprised from an array of rails 205, contact support cores 215, and electrically conductive contacts 210.

The contact support cores 215 are fabricated from a silicone elastomer. Silicone was chosen due for the construction of the contact support cores 215 due to its elasticity, electrical resistance, resistance to take a set, and wide range of temperatures to which it can be exposed while maintaining these characteristics. However, the construction of the contact support cores 215 of the present invention is not limited to silicone, as any compliant material can be used that meets the above-mentioned requirements. Within aspects of the present invention, the contact support cores 215 comprise a longitudinal length; wherein the width of the contact support cores 215 can be configured to comprise a variety of geometric cross-sectional shapes (e.g., circular, triangular, square or cross-beam shapes). A foremost concept of the present invention is to provide a contact support core 215 that is constructed from an elastomer, the contact support core 215 being utilized to provide support and retention spring properties to the electrically conductive contacts 210 that it supports.

The rails 205 are required to be fabricated from a hard, non-conductive material. The rails 215 are used to align the contact support cores 215 in such a way that the spacing of the contacts points of the grid 200 are consistent with that of the electrical pads located on a system processor and system board. As mentioned above, the electrically conductive contacts 210 are fabricated from beryllium copper (BeCu) because of the materials excellent electrical conducting, and physical springing deformation characteristics. The combination of the material an electrically conductive contact 210 is made of, the thickness of the electrically conductive contact 210, and the rigidity of the elastomer contact support core 215 allow for a wide range of adaptability in defining the force required to compress an electrically conductive contact 210.

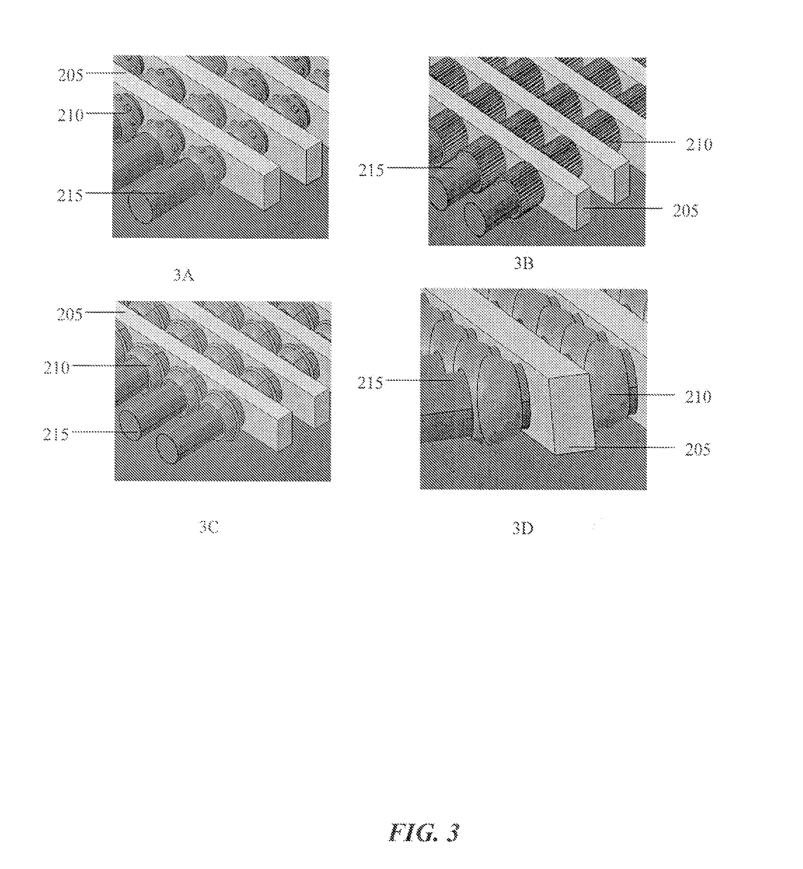

The electrically conductive contacts 210 can comprise the geometry of an annular cylinder (e.g., a bushing, or for increased contact area, a ring for increased force at the point of contact). This configuration additionally provides for the improved physical contact between the connector 100, a system processor 105 and a system board 110, even in the event that oxidation, or contaminations are present, thus ensuring an excellent electrical connection. The electrically conductive contacts 210 are constructed to comprise a continuous piece of material, thus allowing for a higher current carrying capacity. As shown in FIGS. 3A-3D, the outer surface area of the electrical conductive contacts 210 can comprise a plurality of geometrical configurations (e.g., a raised disc or button surface area, a notched surface area, a raised ring, or a flat surface area, as respectively shown in the views of FIGS. 3A-3D). The electrically conductive contacts 210 as shown are not limited to these described structural geometries, but can comprise any structural configuration that is conducive to creating an electrically conductive surface geometry, as to be determined by the needs of an MCM package.

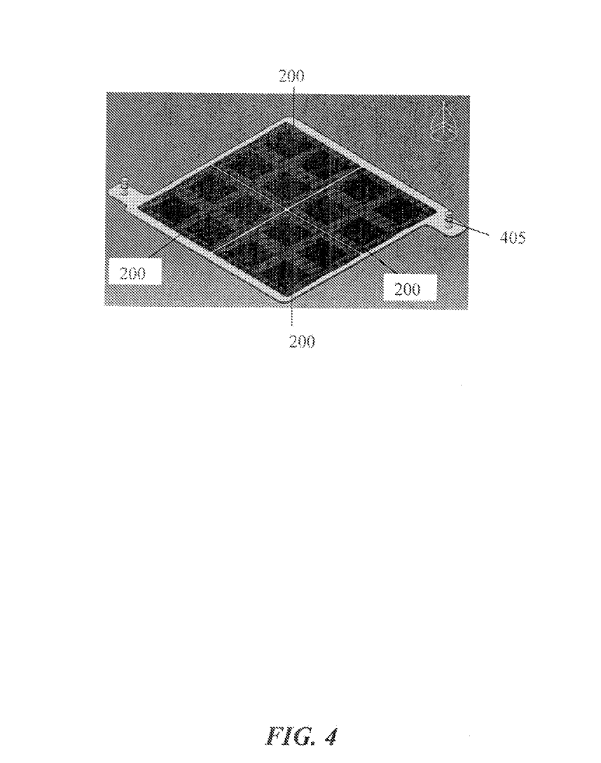

FIG. 4 shows a connector 100, wherein the connector 100 comprises a grouping of four contact grid 200 segments that are mounted upon a rigid frame segment 405, the frame segment serves the purposes of providing support to a contact grid(s), and further as the means for connecting a contact grid(s) 200 to a processing circuit 105 and a system board 110. As shown, the support frame 405 comprises four separate frame quadrants, with each frame quadrant being configured to support a contact grid 200. Within aspects of the invention, there is no requisite contact grid 200 framing quadrant requirement for the configuration of a support frame 405. A support frame 405 can be configured to be a support means for a single contact grid 200 or multiple contact grids 200; the configuration of the connector component 100 depending upon the requirements of the configuration of the MCM. Further, the support frame 405 is used to hold and position the four identical contact grid 200 quadrants, as shown in FIG. 4, but the quadrants are not limited to being identical to each one another. The support frame 405 quadrants, or contact grid arrays of the connector can be configured to have differing pitches, differing number of contacts, and differing contact configuration.

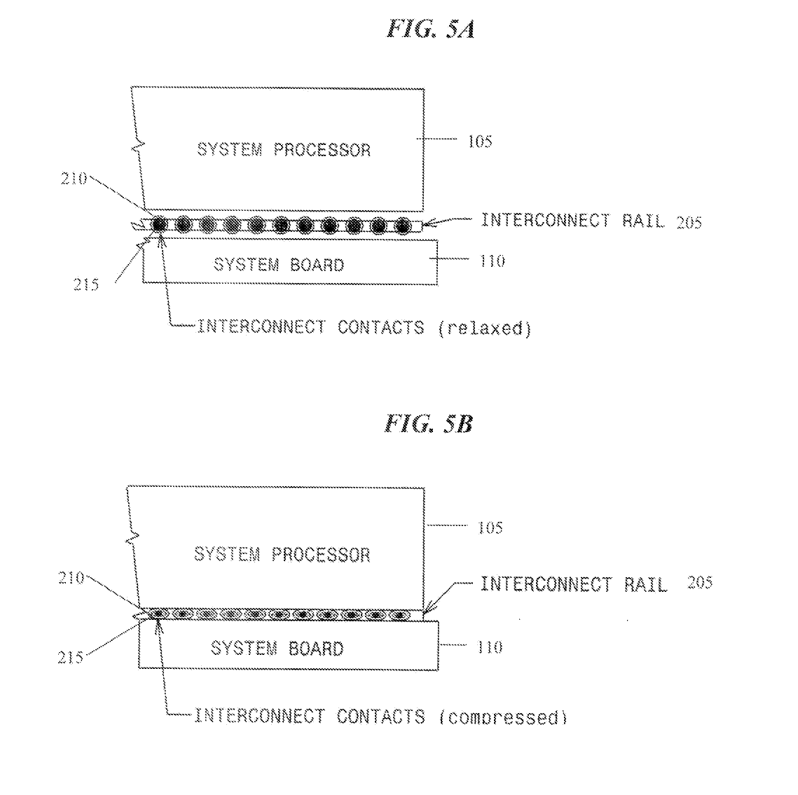

Further, as shown in FIGS. 5A-5B, the rails 205 serve to constrain, or regulate the amount of deflection of the electrically conductive contacts 210. The rails 205 act as a hard stop between a system processor 105, and a system board 110, regulating the amount of deflection on the electrically conductive contacts 210 regardless of the amount of force applied to the system processor 105, and system board 110. Within further aspects of the present invention, nonconductive spacers can be mounted on the contact support cores 215, thereby providing the spacing between contacts on the same contact support core 215, leaving the rails 205 to provide contact support core 215 alignment, and contact deflection.

FIG. 5A shows the interconnecting apparatus 100 between the MCM substrate (system processor 105) and the system board 110, in a decompressed, or connected mode. The interconnect apparatus electrically connects the pads (not shown) of the processor 105 to the board 110 via the electrically conductive contacts 210. The pads are situated above and below each of the electrically conductive contacts 210. The distance that each electrically conductive contact 210 protrudes above and below the rails 205 defines the deflection amount of the electrically conductive contact 210. The amount of deflection required in an electrically conductive contact 210 is based on the configuration of the MCM substrate 105 and the board surface 110.

Further shown in FIG. 5B is the interconnect apparatus 100 compressed between the system processor 105 and the system board 110 in the compressed, or connected mode. The physically interconnecting apparatus 100 now electrically connects the pads of the system processor 105 and the system board 110 via the electrically conductive contacts 210. The pads of the system processor 105 and the system board 110 would be above and below the round electrically conductive contacts 210, which now have an elliptical shape because they're compressed against the contact support cores 215. The amount of deflection being controlled by the grid 200 interconnecting rails 205.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A connector component for the electrical interconnection of electrical components, the connector component comprising:
a framing segment, wherein the framing segment is a planar surface having a top surface and a bottom surface;
a planar grid, having a top planar surface and a bottom planar surface, constructed from a plurality of contact support cores, rails, and conductive annular cylinders, wherein:
the conductive annular cylinders comprise an outside surface, the outside surface area of the conductive annular cylinders further comprising a predetermined geometric configuration;
the rails are formed with a plurality of holes that are spaced a predetermined distance apart from one another along the length of the body of the rail;
the plurality of contact support cores longitudinally extend through the holes that are formed within the plurality rails and the conductive annular cylinders, the rails and conductive annular cylinders being positioned along the length of a contact support core so that a conductive annular cylinder is positioned in the spacing between rails, further, the plurality conductive annular cylinders physically protrude beyond the width of the bodies of the plurality rails to form a conductive contact area surface; and the bottom surface of the planar grid is mechanically mounted to the top surface of the framing segment.

2. The connector component of claim 1, wherein the pluralities of contact support cores are constructed from an elastomer based material.

3. The connector component of claim 2, wherein the rails are constructed from a non-conductive material.

4. The connector component of claim 3, wherein the amount of deflection within the conductive annular cylinders is determined by the width of the plurality of rails.

5. The connector component of claim 4, wherein the geometric configuration of the surface area of an annular ring can comprise a flat surface area, a notched surface area, a secondary annular ring shape projecting from the surface area of the annular ring, the secondary annular ring having a width less than the annular ring, or a plurality of disks projecting from the surface area of the annular ring.

6. The connector component of claim 5, wherein the frame segment is configured to independently serve as a frame for at least two planar grids.

7. The connective component of claim 6, wherein the at least two planar grids comprise identical configurations of conductive annular cylinders.

8. The connective component of claim 6, wherein the at least two planar grids comprise differing configurations of conductive annular cylinders.

9. A method for forming a connector component for the electrical interconnection of electrical components, the method further comprising the steps of:
constructing a planar grid, the planar grid having a top planar surface and a bottom planar surface, constructed from a plurality of contact support cores, rails, and conductive annular cylinders, wherein:
the conductive annular cylinders comprise an outside surface, wherein the outside surface area of the conductive annular cylinders further comprise a predetermined geometric configuration;
the rails are formed with a plurality of holes that are spaced a predetermined distance apart from one another along the length of the body of the rail;
the plurality of contact support cores longitudinally extend through the holes that are formed within the plurality rails and the conductive annular cylinders, the rails and conductive annular cylinders being positioned along the length of a contact support core so that a conductive annular cylinder is positioned in the spacing between rails, further, the plurality conductive annular cylinders physically protrude beyond the width of the bodies of the plurality rails to form a conductive contact area surface; and
constructing a framing segment for the planar grid, wherein the framing segment is a planar surface having a top surface and a bottom surface; and
mechanically mounting the bottom surface of the planar grid to the top surface of the framing segment.

10. The method of claim 9, wherein the pluralities of contact support cores are constructed from an elastomer based material.

11. The method of claim 9, wherein the rails are constructed from a non-conductive material.

12. The method of claim 10, wherein the amount of deflection within the conductive annular cylinders is determined by the width of the plurality of rails.

13. The connector component of claim 12, wherein the geometric configuration of the surface area of an annular ring can comprise a flat surface area, a notched surface area, a secondary annular ring shape projecting from the surface area of the annular ring, the secondary annular ring having a width less than the annular ring, or a plurality of disks projecting from the surface area of the annular ring.

14. The method of claim 13, wherein the frame segment is configured to independently serve as a frame for at least two planar grids.

15. The method of claim 14, wherein the at least two planar grids comprise identical configurations of conductive annular cylinders.

16. The method of claim 14, wherein the at least two planar grids comprise differing configurations of conductive annular cylinders.
